(19) United States
(12) Patent Application Publication
(10) Pub. No.: US 2006/0143035 A1
(43) Pub. Date: Jun. 29, 2006

(54) Semiconductor-integrated device, electronics device using the same, and accounting method concerning the use thereof

(76) Inventor: Masaki Ito, Machida (JP)

Correspondence Address: REED SMITH LLP;Suite 1400, 3110 Fairview Park Drive, Falls Church, VA, 22042, US

(21) Appl. No.: 11/072,271

(22) Filed: Mar. 7, 2005

(30) Foreign Application Priority Data
Dec. 28, 2004 (JP) 2004-379275

(51) Int. Cl. G06Q 99/00

(52) U.S. Cl. 705/1

(57) ABSTRACT

Since a semiconductor-integrated device or software that runs on the device is conventionally of a business model to sell it as a component, such device or software does not earn stable profits. In addition, a dynamic reconfigurable processor which dynamically reconfigures a functional cell is capable of realizing a high function, which in turn compels a user to pay an added-value that is not used. To solve the problem, with the present invention, in a semiconductor-integrated device incorporating a reconfigurable circuit and a reconfigurable circuit controller which controls the reconfigurable circuit, the reconfigurable circuit controller executes accounting according to reconfiguration status of the functional cell of the reconfigurable circuit and delivers the accounting information to an external accounting controller.

### CLAIM OF PPRIORITY

The present application claims priority from Japanese application JP 2004-379275 filed on Dec. 28, 2004, the content of which is hereby incorporated by reference into this application.

### BACKGROUND OF THE INVENTION

The present invention relates to semiconductor-integrated devices, and more particularly to a semiconductor-integrated device that incorporates a dynamic reconfigurable circuit. In addition, the invention relates to a semiconductor-integrated device that provides a new business model that performs accounting of usage amount of an electronics device incorporating the semiconductor-integrated device according to the reconfiguration operations.

Dynamic reconfigurable processors (DRPs) have been proposed as accelerators for executing applications that are beyond the computational capability of a general-purpose processor. The DRP, incorporating many computing units, has a feature to enable changing functions of the computing units as well as signal paths between computing units (the functions and the signal paths are collectively called configuration data) by software, and has an advantage to enable changing functions as a whole even after the DRP is manufactured. In particular, the DRP has a feature to enable sizable computations with a few computation units by switching the configuration data while a computation is in progress.

A reconfigurable device which realizes a small-area and high-speed mutual connection network by optimizing signal paths between functional cells (computing units) is disclosed in Japanese Patent Laid-open No. 2002-76883. In addition, a system which executes functions of a plurality of logic cells by selectively linking programming words is disclosed in Japanese Patent Laid-open No. 8-330945.

Further, in “Feature Article [Dynamic Reconfigurable Device: Its Features and Ability] Editorial Office, et al., Design Wave Magazine, August Issue, Vol. 9, No. 8, Serial No. 81, CQ Publishing Co., Ltd.”, history and summary of dynamic reconfigurable devices, and detailed description of implementation of specific devices are stated.

A business concerning semiconductor-integrated devices is so far considered as a business model that is sold as a component. Since sales or profit is subject to demand for a device in which the semiconductor-integrated device is incorporated, the business has not been structured to ensure stable profit. In addition, regarding a business concerning software (preinstalled) which runs on a semiconductor-integrated device (processor), despite that the development man-hour and the development period have been immense, the price of software provided by a semiconductor supplier is included as part of the semiconductor price and independent value thereof is hard to be accepted in most cases. Therefore, it is also difficult for the business to realize stable profit. The reason why businesses of processors and software that runs on the processors are treated as component-selling business models is wholly attributed to the fact that manufacturers or sellers cannot grasp the status how they are used. In other words, there was a problem in that it is difficult for manufacturers or sellers to grasp the use status of processors or software that run on processors.

Further, the above-described DRP is a highly potential technology in terms that functions of functional cells and connection networks by using software, and not by using a static circuit. However, since the circuit is of a new architecture, circuit designing and software development related to the architecture are mandatory. Furthermore, on the one hand, to disseminate semiconductor-integrated devices that incorporate the DPR, it is preferable that they should be adopted as major components of cell phones and digital still cameras which are popular on commercial markets by reducing the cost through mass production.

The present invention is made to solve the above-stated problems, and it is an object of the invention is, in a business model concerning a semiconductor-integrated device that incorporates the DRP, to provide a business model that can be beneficial to both business firms and users concerned, by enabling accounting on users of an electronics device incorporating the semiconductor-integrated device according to the degree of use.

### SUMMARY OF THE INVENTION

With the DRP of the present invention, attention is focused on execution of configuration data while switching them, and means for grasping the execution status is incorporated in a controller of the DRP. Accounting is made according to the reconfiguration status in the semiconductor-integrated device. Means is provided which delivers the accounting information thus grasped in the above steps to the manufacturer or the seller of the device.

Provision of the above-stated means enables the manufacturer of the seller of the semiconductor-integrated device to grasp types, frequency of use and amount of configuration data (i.e. software), and further enables accounting according to the status of use. Furthermore, it is possible to change the structure of a business model of a semiconductor-integrated device or software to a stable structure that ensures earnings so far as the device or the software is used, from the component-selling structure in which profits are subject to demand for the devices.

As stated above, according to the present invention, in a business model concerning a semiconductor-integrated device that incorporates the DRP, it is possible to provide a business model that is beneficial to both the business firms and users concerned, by enabling accounting on users of an electronics device incorporating the semiconductor-integrated device according to the degree of use.

### BRIEF DESCRIPTION OF THE DRAWINGS

FIG. 1 is a block diagram showing a configuration of a semiconductor-integrated device incorporating a dynamic reconfiguration processor according to the present invention;

FIG. 2 is a block diagram showing a configuration of a semiconductor-integrated device incorporating a dynamic reconfiguration processor according to a related art;

FIG. 3 is a block diagram showing a function of a semiconductor-integrated device that is mounted in a cell phone;

FIG. 4 is a diagram showing comparison of specific data of a radio function and a TV function;

FIG. 5 is a diagram showing a flow of articles and information regarding a business model according to the first embodiment of the present invention;

FIG. 6 is a diagram showing a flow of commodities regarding a business model according to a first embodiment of the present invention;

FIG. 7 is a flow chart showing a flow of accounting information processes;

FIG. 8 is a block diagram simply illustrating a configuration of a camera part that is related to execution of the present invention;

FIG. 9 is a diagram showing a flow of articles and information regarding a business model according to a second embodiment of the present invention;

FIG. 10 is a diagram showing a flow of commodities regarding a business model according to the second embodiment of the present invention;

FIG. 11 is a flow chart showing processes to capture information on semiconductor IP charge recorded on a memory card into an accounting information storage unit 57; and

FIG. 12 is a flow chart showing further details of a reconfigurable processor control process among accounting information processes.

### DESCRIPTION OF THE PREFERRED EMBODIMENTS

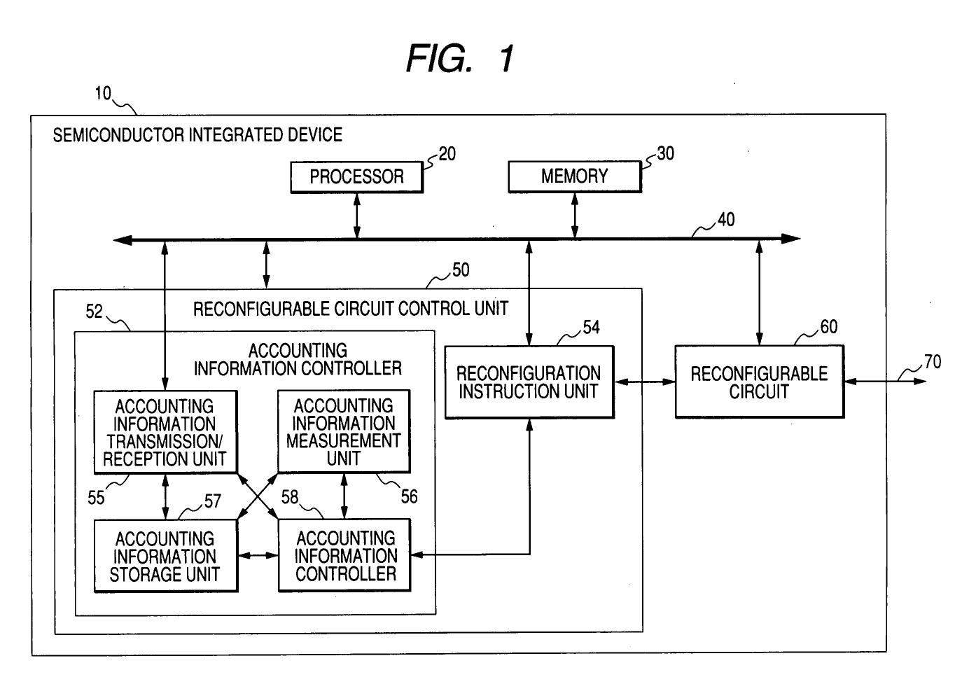

Preferred embodiments according to the present invention will be below described with reference to FIGS. 1 to 12.

[Configuration of a Semiconductor-Integrated Device Incorporating a Dynamic Reconfiguration Processor]

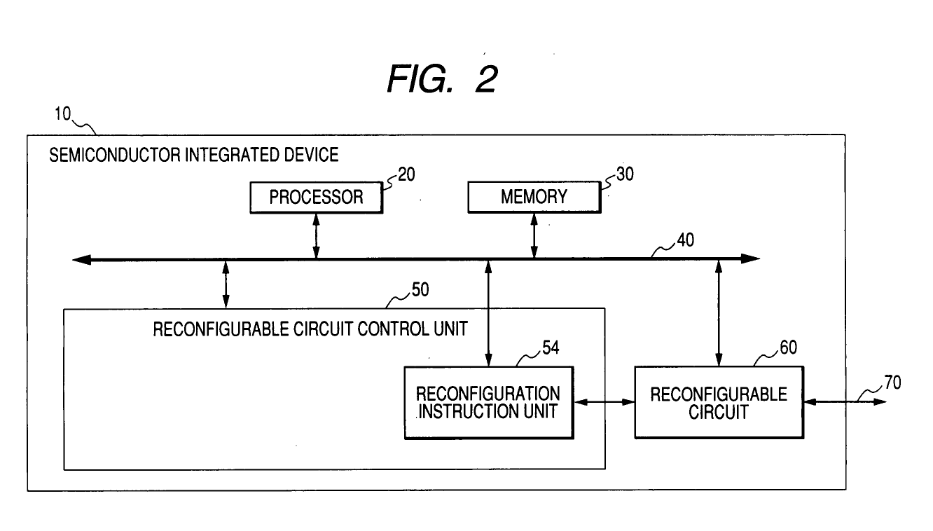

First, a semiconductor-integrated device incorporating a dynamic reconfiguration processor according to the present invention will be described with reference to FIGS. 1 and 2.

FIG. 1 is a block diagram showing a configuration of the DRP incorporating a dynamic reconfiguration processor according to the present invention.

FIG. 2 is a block diagram showing a configuration of a semiconductor-integrated device incorporating a dynamic reconfiguration processor according to a related art.

A semiconductor-integrated device 10 incorporating a dynamic reconfiguration processor according to a prior art is configured, as shown in FIG. 2, to include a general-purpose processor 20, a memory 30, a reconfigurable circuit 60, a reconfigurable circuit control unit 50, and other internal constituent elements, which are further connected to one another via an internal bus 40. A plurality of such elements may each be mounted in a mixed manner in some cases.

The reconfigurable circuit 60 is capable of exchanging data via the internal bus 40. However, since the high-speed nature of such operation may not always be fully utilized due to the speed or the traffic status of the bus, the reconfigurable circuit 60 may some times be provided with an external I/O signal line 70 of its own as shown in FIG. 2.

In the reconfigurable circuit control unit 50, a reconfiguration instruction unit 54 instructs the reconfiguration circuit 60 to reconfigure the functions and connections of functional cells. In general, a small processor, such as a programmable sequencer is used for this purpose. Having a function to instruct reconfiguration means that the reconfigurable circuit control unit 50 grasps reconfiguration information: when and what reconfiguration is made in the reconfigurable circuit 60 and what computations are being executed.

On the other hand, the semiconductor-integrated device according to the present invention will have the configuration shown in FIG. 1. More specifically, sections other than the reconfigurable circuit control unit 50 are configured in the manner similar to the semiconductor-integrated device of the prior art. The reconfigurable circuit control unit 50 newly includes an accounting information controller 52 in addition to the reconfiguration instruction unit 54.

The information management unit 52 includes an accounting information transmission/reception unit 55, an accounting information measurement unit 56, an accounting information storage unit 57 and an accounting information controller 58. Further, the reconfiguration instruction unit 54 has a function to exchange reconfiguration information with the accounting information controller 58, in addition to the semiconductor-integrated device of the prior art shown in FIG. 2.

The accounting information controller 58 receives the reconfiguration information from the reconfiguration instruction unit 54 and transfers the information to the accounting information measurement unit 56. At this time, as instructed by the accounting information controller 58, the accounting information measurement unit 56 may directly receive the reconfiguration information from the reconfiguration instruction unit 54.

The accounting information measurement unit 56 computes accounting information based on the reconfiguration information thus received.

Possible accounting methods related to reconfiguration include, for example: the number of reconfiguration times; the number of execution cycles of the reconfigurable circuit 60; the number of executed computations of the reconfigurable circuit 60; data amount processed by the reconfigurable circuit 60; the number of execution times of an application using the reconfigurable circuit 60; and the number of execution days/months of the reconfigurable circuit 60. More specifically, the accounting information measurement unit 56 has a function to measure items to be measured, including the number of reconfiguration times stated above, and a function to update/store such items to be measured.

The accounting information controller 58 makes an instruction to transfer the accounting information computed by the accounting information measurement unit 56 to the accounting information storage unit 57. Upon receiving the instruction, the accounting information storage unit 57 stores the accounting information. Further, the accounting information thus stored is transferred to the accounting information transmission/reception unit 55, and then, the accounting information transmission/reception unit 55 delivers authentication information and the accounting information to an external accounting management device. As for the timing of executing the transfer, the data may be transferred periodically, for example, every day, every week and every month, or alternatively, the data may be transferred whenever the accounting amount has reached a prescribed value.

[Specific Example of Reconfiguration and Accounting]

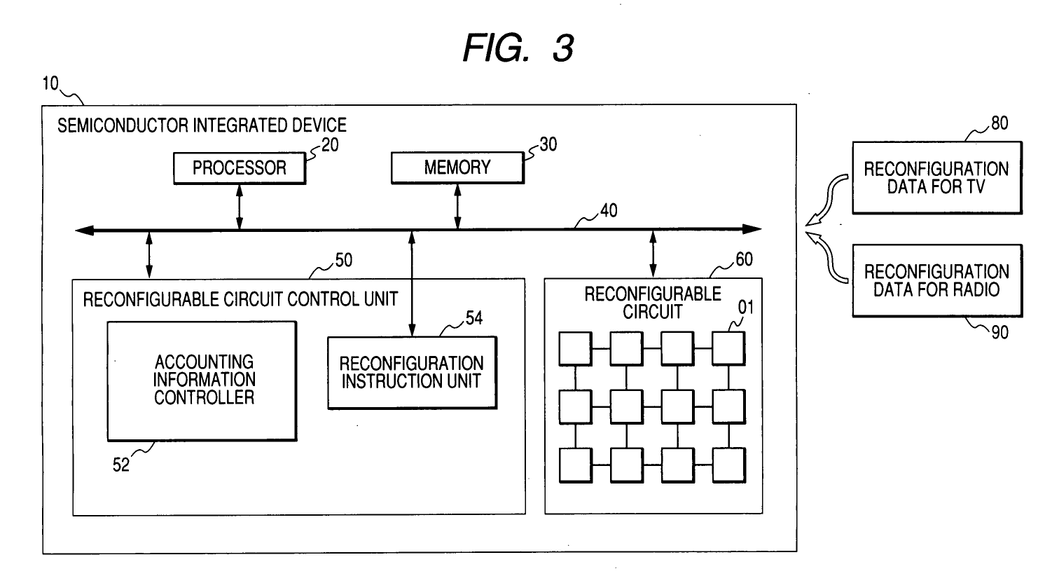

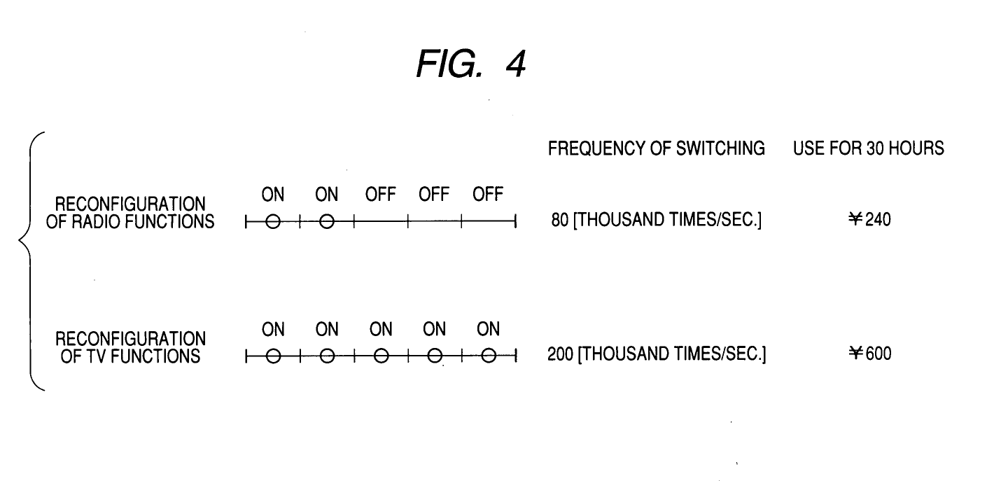

Next, specific examples of reconfiguration and accounting of the semiconductor-integrated device 10 incorporating the DRP will be described with reference to FIGS. 3 and 4.

FIG. 3 is a block diagram showing a function of a semiconductor-integrated device that is mounted in a cell phone.

FIG. 4 is a diagram showing comparison of specific data of a radio function and a TV function.

For example, a device that can simultaneously realize a TV function and a radio function by using a system LSI to be mounted in a cell phone will be considered.

To realize a TV function, as shown in FIG. 3, reconfiguration data for TV 80 for the TV function is read from an external source, and a computing function and connection of a functional cell 01 of the reconfigurable circuit 60 are reconfigured. Likewise, when a radio function is realized, reconfiguration data for radio 90 for the radio function is read from an external source, and a computing function and connection of the functional cell 01 of the reconfigurable circuit 60 are reconfigured.

To realize the radio function, it shall be assumed that the number of reconfiguration times can be less than that for realizing the TV function, and only two-fifth of processing time will be in operation. In addition, to realize the TV function, it shall be assumed that the whole processing time, or five-fifth thereof, will be in operation. Under such assumption, the ratio of the number of switching times of reconfiguration will be “radio:TV=2:5.”

More specifically, it shall be assumed that the number of switching times is 80 [thousand times/sec.] to realize the radio function, and 200 [thousand times/sec.] to realize the TV function.

In this case, when the accounting charge for one switching is set to 1/36×10⁻⁶ [yen], the accounting charge for 30-hour use by a user will be 240 yen for radio and 600 yen for TV as shown in FIG. 4.

### First Embodiment

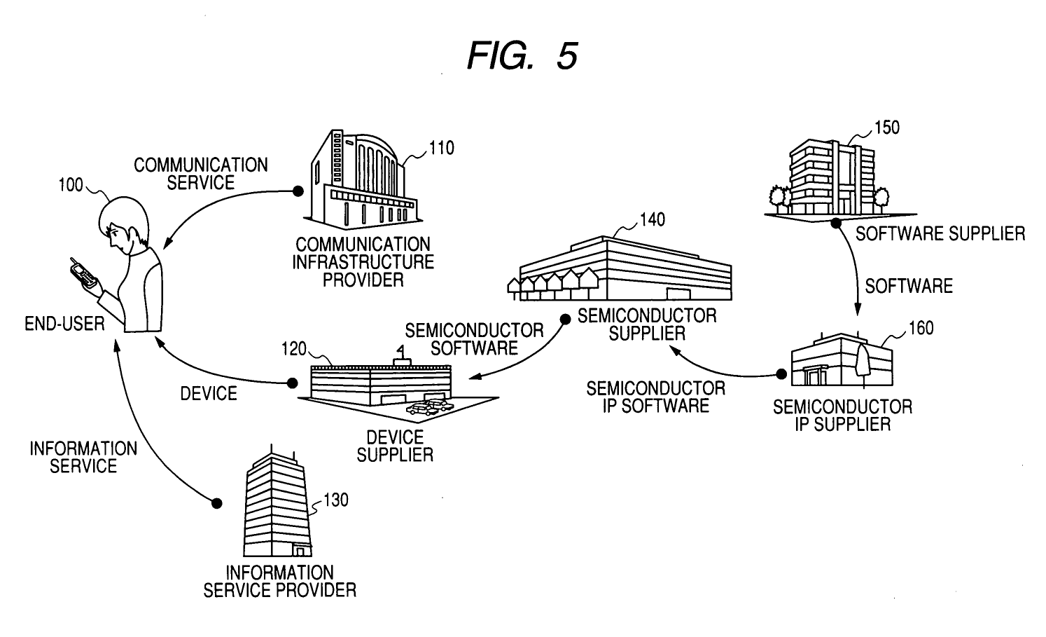

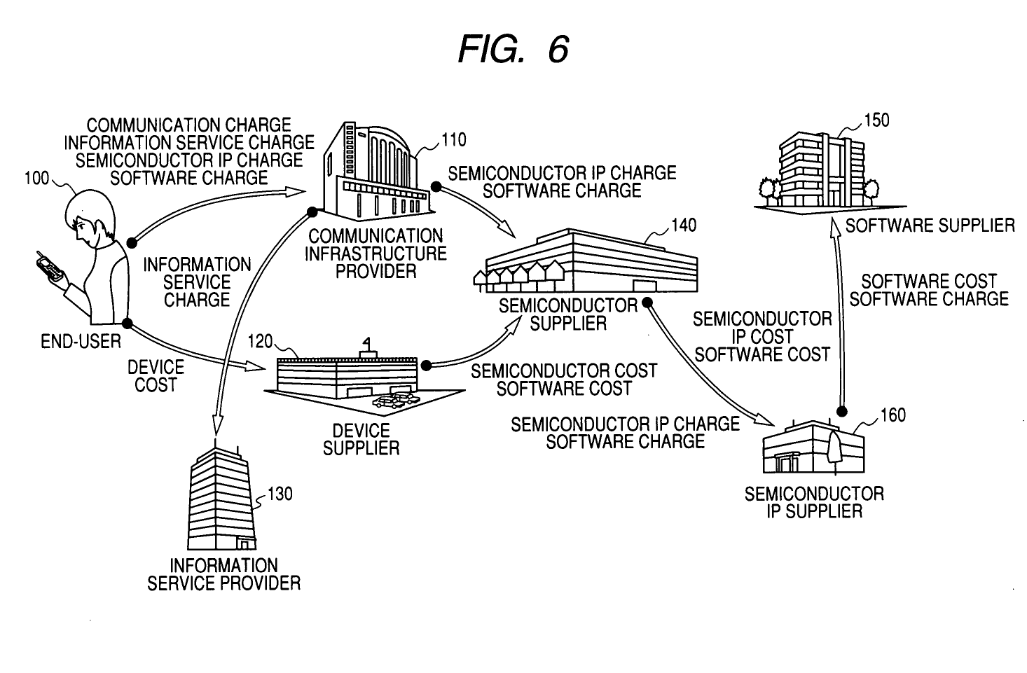

Next, a first embodiment according to the present invention will be described with reference to FIGS. 5 and 6.

In this embodiment, a semiconductor-integrated device incorporating the reconfigurable processor of the present invention is mounted to an electronics device that has a communication capability, or more specifically, a cell phone, etc.

First, a business model according to the first embodiment of the present invention will be described with reference to FIGS. 5 and 6.

FIG. 5 is a diagram showing a flow of articles and information regarding a business model according to the first embodiment of the present invention.

FIG. 6 is a diagram showing a flow of commodities regarding a business model according to the first embodiment of the present invention.

In FIG. 5, a flow of articles and information (i.e. a cell phone as a final product, and software and services to be mounted on the cell phone) is shown with arrow marks, wherein the root of an arrow corresponds to a supply source, and the head of an arrow corresponds to a supply destination.

Participants to the business model include: a semiconductor IP supplier 160; a software supplier 150, a semiconductor supplier 140; a device supplier 120; a communication infrastructure provider 110; an information service provider 130; and an end-user 110.

The semiconductor IP supplier is a company which designs a semiconductor circuit and owns intellectual property concerning the semiconductor circuit. With the embodiment, the company designs the reconfigurable circuit control unit 50 and the reconfigurable circuit 60. The software supplier 150 is a company that develops and markets software used in reconfigurable circuits. The semiconductor supplier 140 is a company that receives design data of the reconfigurable circuit control unit 50 and the reconfigurable circuit 60 from the semiconductor IP supplier, burns the data on a semiconductor, and sells the semiconductor together with the software as a semiconductor device. The device supplier 120 is a company that receives the semiconductor from the semiconductor supplier 140, builds the semiconductor into an electronics device, and sells the device. The communication infrastructure provider 110 is a company that provides a communication infrastructure that enables communication by using the communication function of the device. The information service provider 130 is a company that provides information services or content offered by the electronics device.

Further, the end-user 110 purchases the device from the device supplier 120 and uses information service by using the communication infrastructure of the communication infrastructure provider 110.

It should be noted that individual product and service may sometimes be sold and provided via a sales company such as a distributor. In addition, some of the suppliers and the providers 110 to 160 are sometimes the same companies. For example, the semiconductor IP supplier 160 and the semiconductor supplier 140 could be one and the same company, and, likewise, the semiconductor IP supplier 160 and the software supplier 150 could be one and the same company. With the example shown in FIG. 5, the software product is software to operate the product of the semiconductor IP supplier 160, and a style is assumed in which the semiconductor IP supplier 160 sells the software and the semiconductor IP in a set. However, there is another style of what is called “third-party marketing style”, in which the software supplier 150 directly sells the software to the semiconductor supplier 140, the device supplier 120, or the end-user 100.

Next, flow of commodities under the business model of the embodiment will be described.

In FIG. 6, a flow of commodities (i.e. monetary values) is shown with arrow marks, wherein the root of an arrow corresponds to a payer for the commodity, and the head of an arrow corresponds to a payee.

When an end-user purchases a product, the flow will be as below. The software supplier 150 receives the software cost from the semiconductor IP supplier 160. Next, the semiconductor IP company 160 receives the costs for the semiconductor IP and the software from the semiconductor supplier 140. Further, the semiconductor supplier 140 receives the costs for the semiconductor and the software from the device supplier 120. The device supplier 120 receives the device cost from the end-user 100. Of course, when the software supplier 150 sells the software directly to the semiconductor supplier 140, device supplier 120 or end-user 100 as stated above, the software company 150 will receive the value from respective entities to which the software is sold. Up until this stage, the flow remains the same as that of commodities in the case of conventional semiconductor businesses.

The business model according to the embodiment is different from a conventional business model in the point that an additional flow of commodities occurs when the device is used. When the end-user 100 receives an information service offered by the information service provider 130, by using the communication infrastructure provided by the communication infrastructure provider 110, the end-user 100 pays charges for the communication infrastructure and the information service. With the conventional business model, the communication infrastructure provider 110 collects all the costs and pays the information service charge to the information service provider 130. With the embodiment, in addition to the above, the end-user pays charges for the semiconductor IP and software. The charges are computed based on: the number of reconfiguration times performed by the reconfigurable circuit; the number of execution cycles of the reconfigurable circuit 60; the number of executed computations of the reconfigurable circuit 60; data amount processed by the reconfigurable circuit 60; the number of execution times of an application using the reconfigurable circuit 60; the number of execution days/months of the reconfigurable circuit 60; and others, as stated above. The communication infrastructure provider 110 collects such charges for semiconductor IP and software at the same time when collecting communication charges, etc. The communication infrastructure provider 110 pays the collected amount to the semiconductor supplier 140. The semiconductor supplier 140 further pays charges for semiconductor IP and software to the semiconductor IP supplier 160, and further, the semiconductor IP supplier 160 pays software charge to the software supplier 150. Of course, the communication infrastructure provider 110 may directly pay the charges for semiconductor IP and software to the semiconductor IP supplier 160 or the software supplier 150. Likewise, the semiconductor supplier 140 may directly pay the software charge to the software supplier 150.

Here, the communication infrastructure provider 110 and the semiconductor supplier 140 which mediate the payment can earn an intermediate fee.

The motivation of the end-user to pay the charges for semiconductor IP and the software includes the fact that quality of information service will be dramatically improved as compared with the case of not using a semiconductor IP. When a TV telephone is taken as an example, for a case where a semiconductor IP (the reconfigurable circuit 60 and the reconfigurable circuit control unit 50, here) is not used, the TV telephone does not function, or even if it could function, video/audio quality is poor, like 15 frames/sec. with low QCIF resolution, for example. On the other hand, when a semiconductor IP is used, video images of 30 frames/sec. featuring smooth and quality motions can be obtained with high VGA resolution.

Alternatively, taking a game function as an example as an additional function to a cell phone, etc., when a semiconductor IP is not used, the video offers awkward motions in 2D graphics. However, when a semiconductor IP is used, smooth motions in 3D graphics can be presented.

Further, taking music listening with a cell phone as an example, if a semiconductor IP is not used, tone quality will be as low as that of an AM radio. However, when a semiconductor IP is used, the user can enjoy music with quality tone equivalent to that of CD or 5.1-channel surround sound.

As stated above, when, depending on whether or not a semiconductor IP is used, a significant difference exists in quality of service that an end-user can enjoy, the end-user 100 will have a motive to pay the charge.

Advantages to the end-user 100 include a fact that the system is arranged to bill the device charge according to frequency of use, and the charge is discounted when the function is not used, while the end-user 100 uses a device featuring a highly potential function.

As for profits to be earned by the communication infrastructure supplier 110, there is a fact, as stated above, that the communication infrastructure supplier 110 can enjoy increased revenue since the supplier can earn an intermediate fee when mediating the charges for the semiconductor IP or the software. It would be also possible for the semiconductor IP supplier to use the increased revenue for improving the communication infrastructure and further providing end-users with advanced functions.

Next, profits to be earned by the information service provider 130 include a fact that the information service provider 130 can enjoy increased revenue by changing service quality depending on whether or not the semiconductor IP is used, and, by setting higher charge for the quality service according to the quality level, as stated above.

Next, profits to be earned by the semiconductor supplier 140 include a fact that the semiconductor provider 140 can also enjoy increased revenue since the supplier can earn an intermediate fee when mediating the charges for the semiconductor IP or the software as is the case with the communication infrastructure supplier 110, and can earn a continued revenue source, not the temporary revenue of conventional component-selling type. In addition, by reflecting the continued revenue source on the price of the semiconductor itself, it is possible to reduce the price of semiconductor itself, thus enabling sales to many more device suppliers 120 due to the enhanced price competitiveness.

At this time, since the semiconductor price is significantly reduced as compared with conventional semiconductors, the device supplier can achieve cost reduction, which ensures enhanced price competitiveness of the device, thus enabling sales to much more end-users 100.

Likewise, the semiconductor IP supplier 160 and the software supplier 150 can earn a continued and new revenue source, not the temporary revenue of conventional component-selling type.

As stated above, according to the present invention, it is possible to realize what is called the Win-Win structure which ensures all participants to enjoy profits.

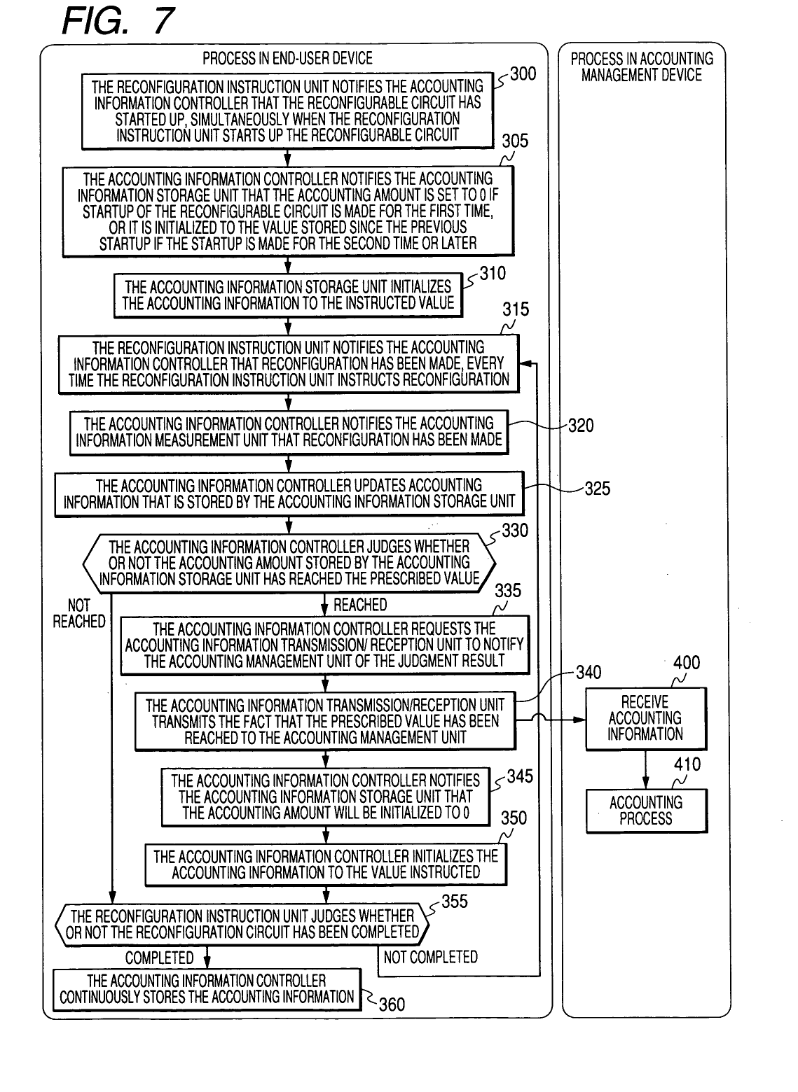

Next, processing of accounting information concerning the first embodiment according to the present invention will be described with reference to FIG. 7.

FIG. 7 is a flow chart showing a flow of accounting information processes.

With the embodiment, it is assumed that the accounting item is the number of reconfiguration times performed by the reconfigurable circuit, and the timing of transferring accounting information is the point when the accounting information has reached the prescribed value.

Among the processes shown in FIG. 7, Steps 300 to 360 are processes that are executed by the semiconductor-integrated device 10 mounted on an electronics device owned by the end-user 100, and Steps 400 and 410 are processes that are executed by the accounting management device or accounting controller.

Usually, an accounting controller is operated by the communication infrastructure supplier 110, but it may sometimes be entrusted to an external organization.

In the semiconductor-integrated device 10, for activation of the reconfigurable circuit 60, the reconfiguration instruction unit 54 issues a startup instruction. At this time, the reconfiguration instruction unit 54 starts up the reconfigurable circuit 60, and, at the same time, it notifies the accounting information controller 58 that the reconfigurable circuit 60 has started up (Step 300). Upon receiving the notification, the accounting information controller 58 sets the accounting amount to 0 if startup of the reconfigurable circuit 60 is for the first time, or, if the startup is the second time or thereafter, it notifies the accounting information storage unit 57 that the accounting amount will be initialized to a value stored since the previous startup (Step 305).

Then, upon receiving the notification, the accounting information storage unit 57 initializes the accounting information to the instructed value (Step 310). On the one hand, the reconfiguration instruction unit 54 remains in operating status, and it notifies the accounting information controller 58 that reconfiguration has been made, every time the reconfiguration instruction unit 54 instructs reconfiguration (Step 315). Upon receiving the notification, the accounting information controller 58 notifies the accounting information measurement unit 56 that reconfiguration has been made (Step 320).

Upon receiving the notification, the accounting information controller 56 updates accounting information that is stored by the accounting information storage unit 57 (Step 325). The accounting information controller 58 judges whether or not the accounting amount stored by the accounting information storage unit 57 has reached the prescribed value as a result of the update (Step 330). If the accounting amount reached the prescribed amount, the accounting information controller 58 requests the accounting information transmission/reception unit 55 to notify the accounting controller of the judgment result (Step 335). Thereafter, upon receiving the notification, the accounting information transmission/reception unit 55 transmits the fact that the prescribed value has been reached and authentication information (usually, the ID unique to the device) to the accounting controller (Step 340).

On the other hand, in Step 330, if the accounting information stored in the accounting information storage unit 57 has not reached the prescribed value, the reconfiguration instruction unit 54 judges whether or not execution of the reconfiguration circuit has been completed (Step 355). If the execution has not been completed yet, the process returns to step 315. If the execution has been completed, the accounting information storage unit 57 continuously stores the accounting information (Step 360).

In the above description, each of the processing units may be software on the processor, or may be a hardware circuit dedicated to each processing unit. In addition, description is stated in a mode of sequential processing to simplify the description. However, each of the processing units may be operated concurrently unless otherwise definite sequential dependency exists. In particular, since the reconfigurable circuit 60 and the reconfigurable circuit controller 50 are independent hardware circuits, execution of the above-stated steps S300 to S360 do not prevent operation of the reconfigurable circuit 60, nor deteriorates processing performance of the semiconductor-integrated device 10.

On the one hand, in Step 340, the accounting information transmission/reception unit 55 transmits the fact that the prescribed value has been reached and authentication information to an accounting controller. The accounting controller, upon receiving such information (Step 400), identifies the user and executes an accounting process by cross-checking the user management information and the authentication information owned by the accounting controller (Step 410). At this time, the following mode may be applied: the accounting controller notifies the accounting information transmission/reception unit 55 that the accounting process has been completed, or otherwise, the accounting information transmission/reception unit 55 further notifies the accounting information controller 58 of completion of the accounting process, and the accounting information controller 58 proceeds to Step 345 only after receiving the notification.

### Second Embodiment

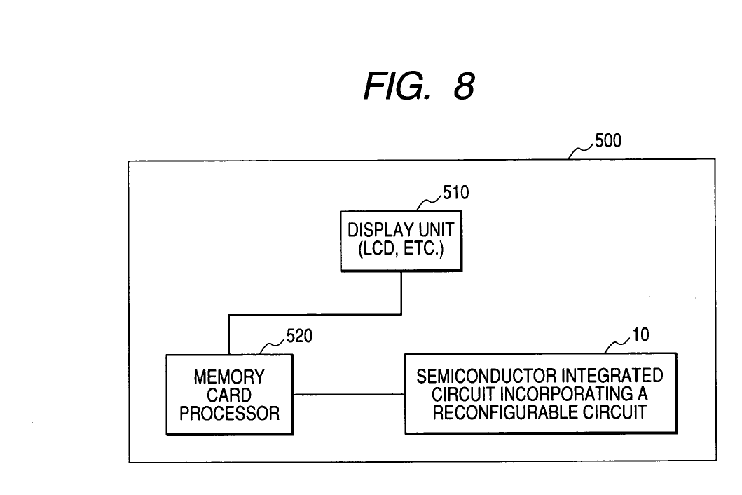

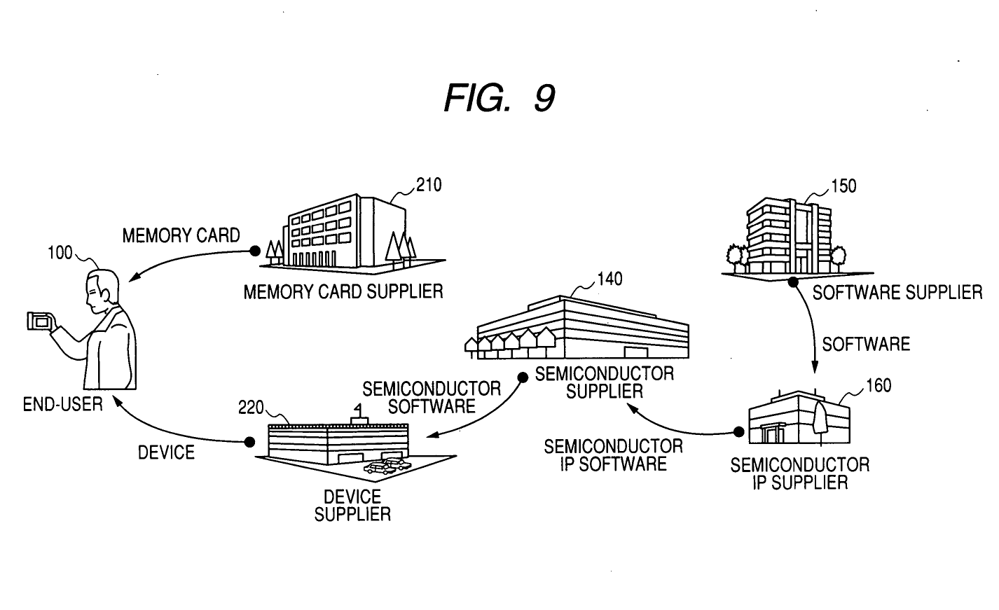

Next, a second embodiment according to the present invention will be described with reference to FIGS. 8 and 9.

With the first embodiment, the description was made of application to a device such as a cell phone having a communication function, thus receiving an information service via a communication infrastructure. On the other hand, the second embodiment refers to a case where a semiconductor-integrated device incorporating the reconfigurable circuit of the present invention is mounted on an electronics device, or more specifically, a digital still camera (hereinafter also referred to a “camera” simply) installing a memory card, which is connected to an external storage device and is accessible thereto.

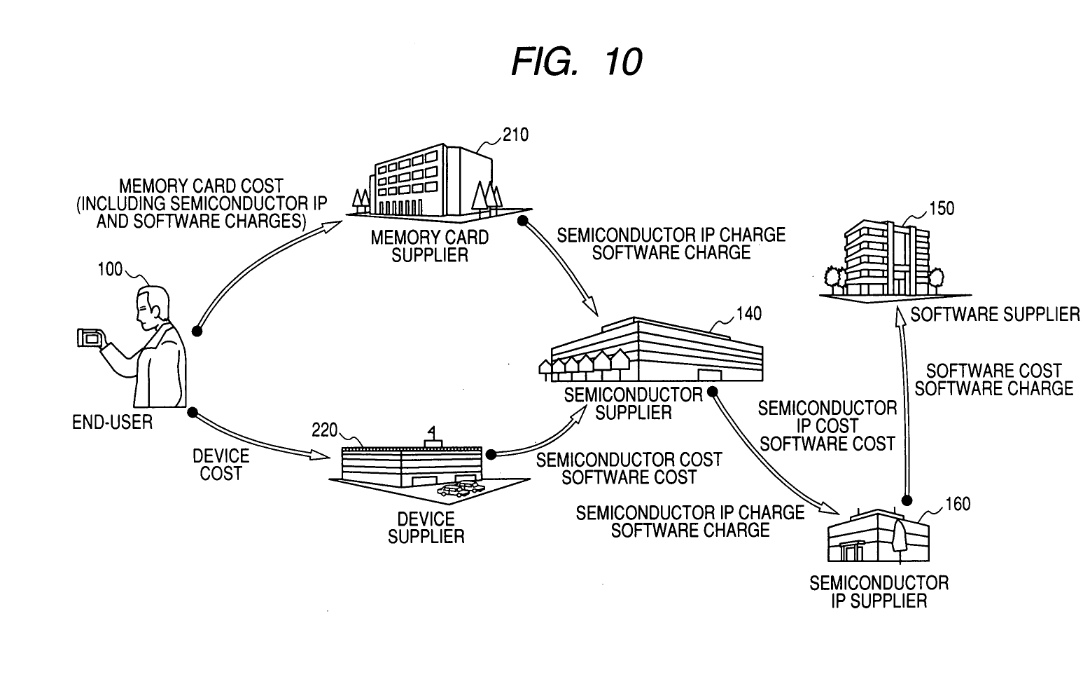

First, a business model associating with the second embodiment of the present invention will be described with reference to FIGS. 8 and 10.

FIG. 8 is a block diagram simply illustrating a configuration of part of a camera related to execution of the present invention.

As is commonly known, while a film camera records an image by exposing it on a film, a digital still camera records an exposed image as digital data. Many of specifications of current digital still camera allow an exposed image to be stored on a memory card such as a CF card and an SD card.

With the business model according to the embodiment, the end-user 100 who uses a device by using the memory card pays a semiconductor IP charge, a software charge, etc. through what we call the prepaid method. More specifically, by purchasing a memory card on which a remaining value of accounting of semiconductor IP charge and software charge is charged, and by inserting the card into the camera, the end-user 100 stores the remaining values of accounting in the accounting information storage unit 57 via the accounting information transmission/reception unit 55 of the semiconductor integrated circuit 10 located in the camera.

The end-user 100 can use the semiconductor IP for the remaining value of accounting of the semiconductor IP charge and the software charge stored. More specifically, the accounting information measurement unit 56 in the first embodiment shown in FIG. 1 has a function to add the number of reconfiguration times, etc., but the second embodiment has a function to subtract the remaining value of accounting for the amount used. In addition, the accounting information controller 58 instructs the reconfiguration instruction unit 54 to stop operations of the reconfigurable circuit 60 when the remaining value of accounting becomes less than a certain level (0, for example). As stated above, the reconfiguration instruction unit 54 has a function to stop operations of the reconfigurable circuit 60. More specifically, the reconfiguration instruction unit 54 stops supplying power or a clock to the reconfigurable circuit 60. Further, the accounting information transmission/reception unit 55 has a function to show the stored remaining value of accounting on the display of the camera and notifies the value to the end-user 100. At this time, it is preferable that a warning indication be displayed when the remaining value of accounting on the memory card is running short.

A camera 500 according to the embodiment includes a memory card processor 520, a display unit 510 and a semiconductor integrated circuit 10 incorporating the reconfigurable circuit 60, as shown in FIG. 8.

Of course, in addition to the above, the camera 500 includes components configuring a camera, for example, a lens, a shutter, a light-sensitive element and a frame buffer, which are omitted in FIG. 8.

Next, a business model according to the second embodiment of the present invention will be described with reference to FIGS. 9 and 10.

FIG. 9 is a diagram showing a flow of articles and information regarding the business model according to the second embodiment of the present invention.

FIG. 10 is a diagram showing a flow of commodities regarding a business model according to the second embodiment of the present invention.

In FIG. 9, a flow of articles and information (i.e. a camera as a final product, and software to be mounted on the camera) is shown with arrow marks, wherein the root of an arrow corresponds to a supply source, and the head of an arrow corresponds to a supply destination.

Participants to the business model include: a semiconductor IP supplier 160; a software supplier 150; a semiconductor supplier 140; a device supplier 120; a memory card supplier 210; and an end-user 110.

The semiconductor IP supplier 160 is a company that designs a semiconductor circuit as is the case with the first embodiment, and it designs a reconfigurable circuit controller 50 and a reconfigurable circuit 60 also in the second embodiment. The software supplier 150 is, as is the case with the first embodiment, a company that develops and markets software intended for use in reconfigurable circuits. In addition, as with the first embodiment, the semiconductor supplier 140 receives design data of the reconfigurable circuit control unit 50 and the reconfigurable circuit 60 from the semiconductor IP supplier 160, and manufactures/sells semiconductor devices.

The device supplier 220 is a company that receives the semiconductor from the semiconductor supplier 140, builds the semiconductor into an electronics device, and sells the device. The memory card supplier 210 is a company that manufactures/sells a memory card that makes the reconfigurable circuit 60 in the semiconductor integrated circuit of the device executable. The end-user 110 purchases a device and a memory card from the device supplier 120 and the memory card supplier 210, respectively, and uses functions of the device. It should be noted that individual product and service may sometimes be sold via a sales company such as a distributor. In addition, some of the companies 120 to 160, 210 and 220 are sometimes the same companies.

Next, a flow of commodities under the business model of the embodiment will be described.

As shown in FIG. 10, as is the case with the first embodiment, a flow of commodities (i.e. monetary values) is shown with arrow marks, wherein the root of an arrow corresponds to a payer for the commodity, and the head of an arrow corresponds to a payee.

The flow of commodities will be as follows when purchasing and using respective products.

The software supplier 150 receives the software cost from the semiconductor IP supplier 160. Then, the semiconductor IP supplier 160 receives the semiconductor IP cost and the software cost from the semiconductor supplier 140. Further, the semiconductor supplier 140 receives the semiconductor IP cost and the software cost from the device supplier 220. The device supplier 220 receives the device cost from the end-user 100. Of course, as stated above, when the software supplier 150 sells the software directly to the semiconductor supplier 140, the device supplier 220 or the end-user 100, the software supplier 150 will receive the value from respective entities to which the software is sold. Up until this stage, the flow remains same as that of the conventional semiconductor businesses.

With the embodiment, the business model is different from a conventional business model in the point that an additional flow of commodities occurs when the device is used. The end-user 100 purchases a memory card sold by the memory card supplier 210. At this time, the memory card cost includes the semiconductor IP charge and the software charge. In other words, the semiconductor IP charge and the software charge are charged in the prepaid type of accounting method. Further, the end-user 100 inserts the memory card into the device to enable use of each function. Conventionally, concerning the use of semiconductors, there was no case of collecting charges in the prepaid method, but, with the embodiment, the memory card supplier 210 pays the semiconductor IP charge and the software charge to the semiconductor supplier 140 by using part of the charge prepaid by end-users. The semiconductor supplier 140 further pays the semiconductor IP charge and the software charge to the semiconductor IP supplier 160, and the semiconductor IP supplier 160 further pays the software charge to the software supplier 150. Of course, the memory card supplier 210 may directly pay the semiconductor IP charge and the software charge to the semiconductor IP supplier 160 and the software supplier 150. Likewise, the semiconductor supplier 140 may directly pay the software charge to the software supplier 150.

Here, the memory card supplier 210 and the semiconductor supplier 140 which mediate the payment can earn an intermediate fee.

In this case, the motive of the end-user 100 to pay the semiconductor IP charge and the software charge arises, as is the case with the above-described mode, from giving more significant difference in functions that the end-user 100 can enjoy than the case of using no semiconductor IP or software.

More specifically, possible examples include the case where, when the semiconductor IP is not used, the digital still camera can take still pictures, and the case where, when the semiconductor IP is used, the camera can take video pictures as well. The example also include another case where, when the semiconductor IP is not used, fast continuous shooting is not feasible or the number of continuous shots is limited to about 5 pictures/sec., or the case where, when the semiconductor IP is used, the fast continuous shooting can be extended to 10 pictures/sec. and over. Furthermore, possible examples include the case where, when the semiconductor IP is not used, the resolution is about 3 million pixels, and the case where, when the semiconductor IP is used, the resolution becomes about 5 million pixels.

As stated above, when a significant difference in quality of service receivable by an end-user exists depending on whether or not the semiconductor IP is used, the end-user 100 will have a motivation to pay the charge for the service. Further, the end-user 100 who does not use such function will have an advantage to obtain the device at a low price since the cost of the semiconductor-integrated device to be mounted will be reduced.

Next, advantages that the memory card supplier 210 can enjoy include that the supplier can secure a continuous revenue source, since, as stated above, the memory card supplier 210 can earn intermediate fee when mediating the semiconductor IP charge or the software charge, and further the supplier can sell the memory card whenever the device is used. Consequently, it is possible to reduce the price of the memory card itself, thus ensuring price competitiveness.

Next, advantages that the semiconductor supplier 140 can enjoy include that, likewise the case of the memory card supplier 220, the semiconductor supplier 140 can also earn intermediate fee when mediating the semiconductor IP charge or the software charge, thus ensuring a continuous revenue source in stead of a temporary revenue of conventional component-selling type. In addition, reflection of the continuous revenue on the price of the semiconductor-integrated device itself will ensure reduction in the price of the semiconductor-integrated device itself, which ensures price competitiveness to enable sales to further more device suppliers 220.

At this time, the device supplier 220 can achieve cost reduction since the semiconductor prices becomes significantly lower than that of conventional semiconductors, which ensures price competitiveness to enable sales to further more end-users 100.

Likewise the case of the semiconductor IP supplier 160 and the software supplier 150, they can earn a continuous and new revenue source instead of a temporary revenue of conventional component-selling type.

As stated above, according to the present invention, it is possible to realize what is called the Win-Win structure which ensures all participants to enjoy profits.

It should be noted that a business model wherein the semiconductor IP charge and the software charge are added to the memory card cost was described in the above. However, such charging of remaining value of accounting may be executed at a location to which the end-user 100 can easily access, for example, a convenience store, a kiosk at a station, an automatic vending machine or the like. In addition, enabling the remaining value of accounting to be charged on the Internet will further enhance convenience for the end-user 100.

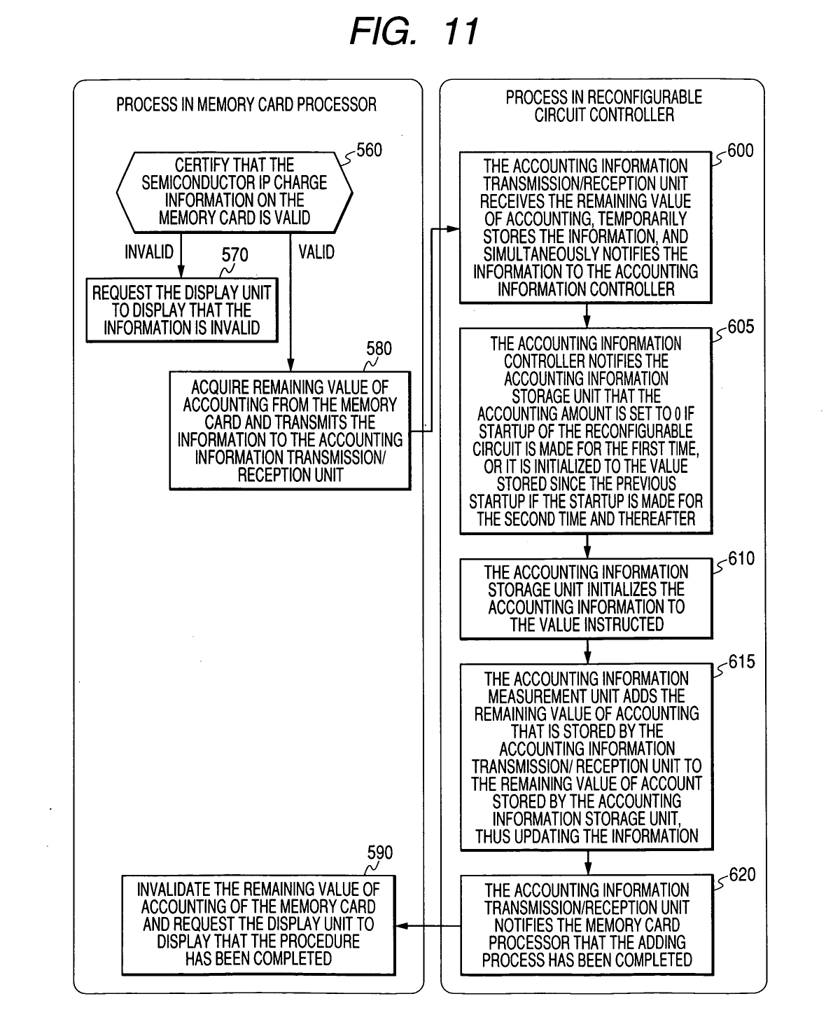

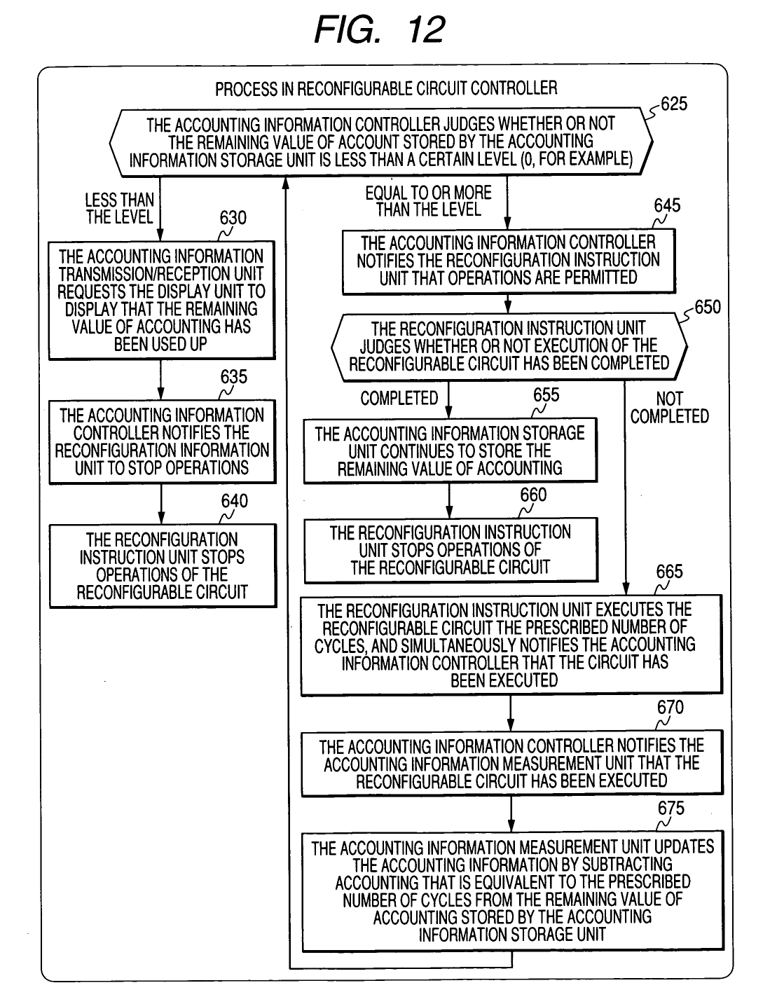

Next, processes of accounting information according to the first embodiment of the present invention will be described with reference to FIGS. 11 and 12.

FIG. 11 is a flow chart showing processes to capture information on semiconductor IP charge that is recorded on a memory card into the accounting information storage unit 57.

FIG. 12 is a flow chart showing further details of a reconfigurable processor control process among accounting information processes.

Among processes shown in FIGS. 11 and 12, Steps 560 to 590 shows processes that are executed in the memory card processor 520 incorporated in the camera 500 owned by the end-user 100, and Steps 600 to 675 are also processes that are executed in the semiconductor-integrated device 10 incorporated in the camera 500 owned by the end-user 100.

When a memory card is inserted to the memory card processor 520 of the camera 500, the memory card processor 520 first authenticates that information such as semiconductor IP charge information and the software charge information recorded on the memory card is valid (Step 560). If the information is invalid, the memory card processor 520 requests the display unit 510 to display that the semiconductor IP charge information, the software charge information, etc. are not valid on the display unit 510 of the camera 500, and terminates the process (Step 570). Then, the display unit 510 displays that the semiconductor IP charge information, the software charge information, etc. are not valid. If such information is valid, the display unit 510 obtains remaining value of accounting of the semiconductor IP charge, the software charge, etc. from the memory card and transmits the information to the accounting information transmission/reception unit 55 (Step 580).

In the semiconductor-integrated device 10, the accounting information transmission/reception unit 55 receives the remaining value of accounting, temporarily stores the information, and simultaneously notifies the information to the accounting information controller 58 (Step 600). Upon receiving the notification, the accounting information controller 58 notifies the accounting information storage unit 57 that the accounting amount is set to 0 if startup of the reconfigurable circuit is made for the first time, or it is initialized to the value stored since the previous startup if the startup is made for the second time and thereafter (Step 605). Upon receiving the notification, the accounting information storage unit 57 initializes the accounting information to the value instructed (Step 610).

Next, the accounting measurement unit 56 adds the remaining value of accounting that is temporarily stored by the accounting information transmission/reception unit 55 to the remaining value of account stored by the accounting information storage unit 57, thus updating the information (Step 615). Then, the accounting information transmission/reception unit 55 notifies the memory card processor 520 that the adding process has been completed (Step 620). The memory card processor 520, upon receiving the notification, invalidates the remaining value of accounting of the memory card and requests the display unit 510 to display that the procedure has been completed (Step 590). Then, the display unit 510 displays that the remaining value of accounting recorded on the memory card has been captured into the camera.

Next, according to the remaining value of accounting thus captured, a flow to process accounting information when the camera is used will be as below as shown in FIG. 12.

The accounting information controller 58 first judges whether or not the accounting information stored by the accounting information storage unit 57 is less than a certain level (0, for example) (Step 625). If the information is less than the level, the accounting information transmission/reception unit 55 requests the display unit 510 to display that the remaining value of accounting has been used up (Step 630). Upon receiving the request, the display unit 510 displays that the accounting information has been used up. Next, the accounting information controller 58 notifies the reconfiguration instruction unit 54 to stop operations (Step 635), and the reconfiguration instruction unit 54 stops operations of the reconfigurable circuit (Step 640).

If the remaining value of accounting stored by the accounting information storage unit 57 is equal to or more than a certain level (0, for example), the accounting information controller 58 notifies a permission of operation to the reconfiguration instruction unit 54 (Step 645). Upon receiving the notification, the reconfiguration instruction unit 54 judges whether or not execution of the reconfigurable circuit 60 has been completed (Step 650). If the execution has been completed, the accounting information storage unit 57 continues to store the accounting information (Step 655), and the reconfiguration instruction unit 54 stops operations of the reconfigurable circuit 60 (Step 660).

If the execution of the reconfigurable circuit 60 has not been completed, the reconfiguration instruction unit 54 executes the reconfigurable circuit 60 only for the prescribed number of cycles, and simultaneously notifies the accounting information controller 58 that the circuit has been executed (Step 665). Then, the accounting information controller 58 notifies the accounting information measurement unit 56 that the reconfigurable circuit 60 has been executed (Step 670). Upon receiving the notification, the accounting information measurement unit 56 updates the accounting information by subtracting accounting equivalent to the prescribed number of cycles from the remaining value of accounting stored by the accounting information storage unit 57. Thereafter, the process is repeated from Step 625 (Step 675).

In the above description, the mode to realize each of the processing units may be software on the processor, or may be a hardware circuit dedicated to each of the processing units. In addition, description is stated in a mode of sequential processing to simplify the description. However, each of the processing units may be operated concurrently unless otherwise definite sequential dependency exists. In particular, since the reconfigurable circuit 60 and the reconfigurable circuit controller 50 are independent hardware circuits, execution of the above-stated steps S625 to S675 does not prevent operation of the reconfigurable circuit 60, nor deteriorates processing performance of the semiconductor-integrated device 10.

What is claimed is:

1. A semiconductor-integrated device comprising:
a reconfigurable-circuit which realizes a function by reconfiguring functional cells; and
a reconfigurable circuit controller which controls said reconfigurable circuit and gives a reconfiguration instruction thereto;
wherein said reconfigurable circuit controller includes:
a reconfiguration instruction unit which gives an instruction to said reconfigurable circuit; and
an accounting information controller to execute accounting on a function to be realized by said semiconductor-integrated device; and
wherein said accounting information controller includes:
an accounting information measurement unit which measures accounting information according to the reconfiguration status of said functional cells of said reconfigurable circuit;
an accounting information storage unit to store accounting information;
an accounting information transmission/reception unit which transmits and receives accounting information to and from an external source of said semiconductor-integrated device; and
an accounting information controller which controls said accounting information controller.

2. An electronics device having a function to communicate with an external source, said electronics device comprising:
a semiconductor-integrated device which includes:
a reconfigurable circuit to realize a function by reconfiguring functional cells; and
a reconfigurable circuit controller which controls said reconfigurable circuit and gives a reconfiguration instruction thereto; and
wherein said reconfigurable circuit controller includes:
a reconfiguration instruction unit which gives an instruction to said reconfigurable circuit; and
an accounting information controller to execute accounting on a function to be realized by said semiconductor-integrated device; and
wherein said accounting information controller measures accounting information according to reconfiguration status of said functional cells executed by said reconfiguration circuit based on a reconfiguration instruction from said reconfiguration indication unit and performs transmission and reception of information with an external source of said semiconductor-integrated device; and
wherein said electronics device transmits accounting information to be received from said semiconductor-integrated device to an external accounting controller.

3. An electronics device having a connection function with an external storage device, said device comprising:
a reconfigurable circuit to realize a function by reconfiguring functional cells; and
a reconfigurable circuit controller which controls said reconfigurable circuit and gives a reconfiguration instruction thereto;
wherein said reconfigurable circuit controller includes:
a reconfiguration instruction unit which gives an instruction to said reconfigurable circuit; and
an accounting information controller to execute accounting on a function to be realized by said semiconductor-integrated device; and
wherein said accounting information controller receives remaining value of accounting stored in said external storage device, and when the remaining value of accounting is kept, said reconfiguration instruction unit gives a reconfiguration instruction to said reconfigurable circuit to executes reconfiguration of said functional cells.

4. An accounting method concerning use of an electronics device which incorporates a semiconductor-integrated device including a reconfigurable circuit to realize a function by reconfiguring functional cells and which has a communication function, said accounting method comprising the steps of:
when a user of said electronics device enjoys an information service by using said electronics device, reconfiguring functional cells by giving an instruction to said reconfigurable circuit at the time of activating a semiconductor-integrated device to realize said information service;
executing accounting of usage charge of the semiconductor according to reconfiguration status of said configurable circuit; and
transmitting accounting information to an accounting controller of a communication infrastructure supplier which offers a communication service.

5. An accounting method concerning use of an electronics device which incorporates a semiconductor-integrated device including a reconfigurable circuit to realize a function by reconfiguring functional cells and has a function to connect an external storage device, said accounting method comprising the steps of:
when a user of said electronics device uses said external storage device through said electronics device, connecting said external storage device storing a remaining value of accounting of the electronics device to the electronics device;
transmitting the remaining value of accounting of said electronics device from said external storage device;
storing said remaining value of accounting of said electronics device transmitted;
when activating said semiconductor-integrated device to use said electronics device, reconfiguring the functional cells by giving an instruction to said reconfigurable circuit;
subtracting a usage charge from said remaining value of accounting stored according to reconfiguration status of said reconfigurable circuit; and
stopping operations of said electronics device when said remaining value of accounting is used up.
